(19) United States
(12) Patent Application Publication
(10) Pub. No.: US 2014/0313365 A1
(43) Pub. Date: Oct. 23, 2014

(54) VIRTUAL PRESENCE SYSTEM

(71) Applicant: NOKIA CORPORATION, Espoo (FI)

(72) Inventors: Arto Lehtiniemi, Lempaala (FI); Antti Eronen, Tampere (FI); Jukka Holm, Tampere (FI); Juha Henrik Arrasvuori, Tampere (FI)

(73) Assignee: NOKIA CORPORATION, Espoo (FI)

(21) Appl. No.: 13/868,480

(22) Filed: Apr. 23, 2013

(51) Int. Cl. H04N 5/232

(52) U.S. Cl. CPC H04N 5/23229
USPC 348/222.1

(57) ABSTRACT

A method comprising capturing, by a device equipped with a first camera, at least one image about an object of interest; determining at least one of location and orientation information of the device; retrieving, on the basis of at least one of said at least one image and said location and orientation information, at least one image of the object of interest from a service comprising media associated with location information; capturing, by a second camera, at least one image about an object currently locating in the vicinity of the object of interest; creating a cropped image from the at least one image about said object, the cropped image comprising at least a cropped portion of said object; and embedding the cropped image of said object to the at least one image of the object of interest retrieved from said service.

### BACKGROUND

The exponentially increased amount of digital multimedia content available in various applications, along with the exponentially increased processing power of various digital devices, has provided a user of the device with multiple options for creating virtual presence. Virtual presence typically refers to applications where the user is given the impression of being in a simulated environment or seeing someone else as being in a simulated environment. For example, various social network applications may provide images of a group of people, wherein an image may be edited by virtually inserting an image of a person being a member of the group, but not originally being present when the image was taken, into the image.

Users may wish to take images of themselves when visiting new places, and to share the image in a social network service for other users to see. A user may visit, for example, an interesting museum and the user wishes to take a photo of him/herself outside the museum and include some local scenery to the photo for sharing to others. However, it is known to be difficult to take an illustrative picture of oneself together with a distinct image of an object of interest, such as a building, being captured on the background of the image.

On the other hand, users may wish that they had been photographed when they visited a certain location, but there was no camera available at that time. For instance, the user may wish to tag a restaurant that he/she visited yesterday with a “thumbs up” picture.

Thus, there is a need for enhanced methods for creating images where user's image can be combined with local scenery in a distinctive manner and readily shareable in social networks.

### SUMMARY

Now there has been invented an improved method and technical equipment implementing the method for at least alleviating the problems. Various aspects of the invention include a method, apparatuses and computer programs, which are characterized by what is stated in the independent claims. Various embodiments of the invention are disclosed in the dependent claims.

According to a first aspect, there is provided a method comprising: capturing, by a device equipped with a first camera, at least a first image about a first object of interest; determining at least one of location and orientation information of the device; retrieving, on the basis of at least one of said at least one first image and said location and orientation information, at least one second image of the first object of interest from a service comprising media associated with location information; capturing at least one third image about a second object currently locating within a predetermined range from the first object of interest; creating a cropped image from the at least one third image about said second object, the cropped image comprising at least a cropped portion of said second object; and embedding the cropped image of said second object to the at least one second image of the first object of interest retrieved from said service in order to form a fourth image.

According to an embodiment, the third image about the second object is captured by a second camera.

According to an embodiment, the first camera is a back camera of the device and the second camera is a front camera of said device, and said second object is a user of the device.

According to an embodiment, the first camera is a camera of a first device and the second camera is a camera of a second device, and said second object is a user of the first device, the method further comprising sending the at least one third image about the second object to the first device.

According to an embodiment, the method further comprises storing the fourth image in a network server; and sharing access to see the fourth image to at least one further person.

According to an embodiment, the service is a three-dimensional (3D) virtual application providing image views from real geographical locations, such as Google® Street View or Nokia® City Scene.

According to an embodiment, the method further comprises sending the at least one first image about the first object of interest and the location and orientation information together to a server functionally connected to the service for determining the location of the device.

According to an embodiment, said cropped image is an avatar of a person.

According to a second aspect, there is provided an apparatus comprising at least one processor, memory including computer program code, the memory and the computer program code configured to, with the at least one processor, cause the apparatus to at least: capture, with a first camera, at least one first image about a first object of interest; determine at least one of location and orientation information of the device; retrieve, on the basis of at least one of said at least one first image and said location and orientation information, at least one second image of the first object of interest from a service comprising media associated with location information; obtain at least one third image about a second object currently locating within a predetermined range from the first object of interest; create a cropped image from the at least one third image about said second object, the cropped image comprising at least a cropped portion of said second object; and embed the cropped image of said second object to the at least one second image of the first object of interest retrieved from said service in order to form a fourth image.

According to a third aspect, there is provided a computer program embodied on a non-transitory computer readable medium, the computer program comprising instructions causing, when executed on at least one processor, at least one apparatus to: capture, with a first camera, at least one first image about a first object of interest; determine at least one of location and orientation information of the device; retrieve, on the basis of at least one of said at least one first image and said location and orientation information, at least one second image of the first object of interest from a service comprising media associated with location information; obtain at least one third image about a second object currently locating within a predetermined range from the first object of interest; create a cropped image from the at least one third image about said second object, the cropped image comprising at least a cropped portion of said second object; and embed the cropped image of said second object to the at least one second image of the first object of interest retrieved from said service in order to form a fourth image.

According to a fourth aspect, there is provided a method comprising:

receiving a request from a user of a first client terminal to create at least one first image comprising a first object of interest defined by the request and a cropped image of a second object embedded thereto; sending a request to a second client terminal currently locating within a predetermined range from the first object of interest for capturing at least one second image about the first object; receiving, in response to an acknowledgement from the second client device, at least one third image of the second object from the first client terminal; receiving, from the second client device, the at least one second image about the first object of interest; and editing the received images by creating a cropped image from the at least one third image about the second object, and embedding the cropped image of the second object to the at least one second image of the first object of interest captured by the second client terminal in order to create the at least one first image.

According to an embodiment, the second object is a user of the first client terminal.

According to an embodiment, the method further comprises keeping track of places where the user of the first terminal has previously visited; and allowing said requests to be made only in regard such first object of interest residing in places where the user of the first terminal has previously visited.

According to an embodiment, the method further comprises providing the user of the first client terminal with an option for giving instructions to a user of the second client device for adjusting the capturing of the at least one second image of the first object of interest.

According to an embodiment, the editing is carried out in a common editing node, the node being a network server, the first client device or the second client device.

According to a fifth aspect, there is provided an apparatus comprising at least one processor, memory including computer program code, the memory and the computer program code configured to, with the at least one processor, cause the apparatus to at least: receive a request from a user of a first client terminal to create at least one first image comprising a first object of interest defined by the request and a cropped image of a second object embedded thereto; send a request to a second client terminal currently locating within a predetermined range from the first object of interest for capturing at least one second image about the first object; receive, in response to an acknowledgement from the second client device, at least one third image of the second object from the first client terminal; receive, from the second client device, the at least one second image about the first object of interest; and edit the received images by creating a cropped image from the at least one third image about the second object, and embedding the cropped image of the second object to the at least one second image of the first object of interest captured by the second client terminal in order to create the at least one first image.

According to a sixth aspect, there is provided a computer program embodied on a non-transitory computer readable medium, the computer program comprising instructions causing, when executed on at least one processor, at least one apparatus to: receive a request from a user of a first client terminal to create at least one first image comprising a first object of interest defined by the request and a cropped image of a second object embedded thereto; send a request to a second client terminal currently locating within a predetermined range from the first object of interest for capturing at least one second image about the first object; receive, in response to an acknowledgement from the second client device, at least one third image of the second object from the first client terminal; receive, from the second client device, the at least one second image about the first object of interest; and edit the received images by creating a cropped image from the at least one third image about the second object, and embedding the cropped image of second object to the at least one second image of the first object of interest captured by the second client terminal in order to create the at least one first image.

These and other aspects of the invention and the embodiments related thereto will become apparent in view of the detailed disclosure of the embodiments further below.

### LIST OF DRAWINGS

In the following, various embodiments of the invention will be described in more detail with reference to the appended drawings, in which

FIGS. 1a and 1b show a system and devices suitable to be used in a remote control system according to an embodiment;

FIG. 2 shows a flow chart of a virtual presence method according to an embodiment;

FIGS. 3a-3c show an exemplified implementation of the virtual presence method on a mobile device according to an embodiment;

FIG. 4 shows a signaling chart of a virtual presence method according to another embodiment;

FIGS. 5a-5d show an exemplified implementation of the virtual presence method on a mobile device according to the embodiment of FIG. 4.

FIG. 6 shows a diagram of hardware that can be used to implement an embodiment of the invention;

FIG. 7 shows a diagram of a chip set that can be used to implement an embodiment of the invention; and

FIG. 8 shows a diagram of a mobile terminal (e.g., handset) that can be used to implement an embodiment of the invention.

### DESCRIPTION OF EMBODIMENTS

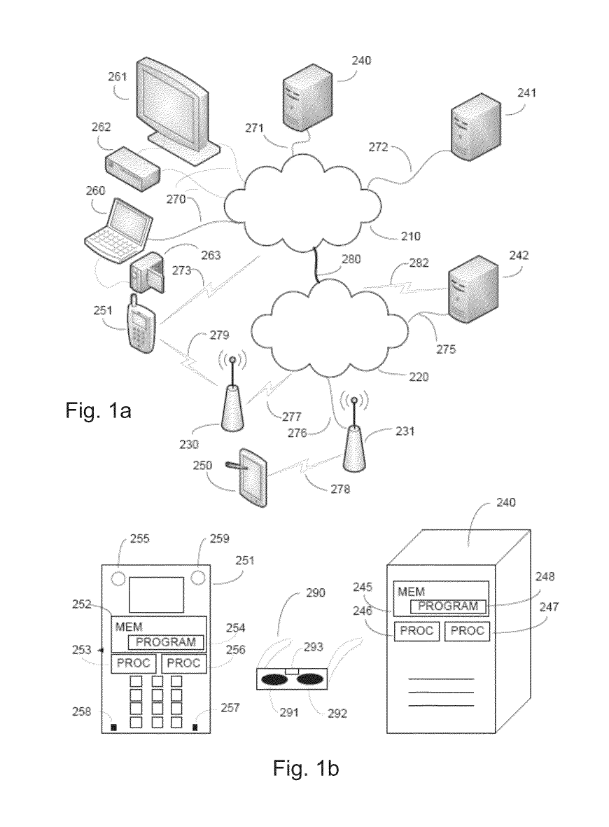

FIGS. 1a and 1b show a system and devices suitable to be used in a virtual presence system according to an embodiment. In FIG. 1a, the different devices may be connected via a fixed network 210 such as the Internet or a local area network; or a mobile communication network 220 such as the Global System for Mobile communications (GSM) network, 3rd Generation (3G) network, 3.5th Generation (3.5G) network, 4th Generation (4G) network, Wireless Local Area Network (WLAN), Bluetooth®, or other contemporary and future networks. Different networks are connected to each other by means of a communication interface 280. The networks comprise network elements such as routers and switches to handle data (not shown), and communication interfaces such as the base stations 230 and 231 in order for providing access for the different devices to the network, and the base stations 230, 231 are themselves connected to the mobile network 220 via a fixed connection 276 or a wireless connection 277.

There may be a number of servers connected to the network, and in the example of FIG. 1a are shown servers 240, 241 and 242, each connected to the mobile network 220, which servers may be arranged to operate as computing nodes (i.e. to form a cluster of computing nodes or a so-called server farm) for the virtual presence system. Some of the above devices, for example the computers 240, 241, 242 may be such that they are arranged to make up a connection to the Internet with the communication elements residing in the fixed network 210.

There are also a number of end-user devices such as mobile phones and smart phones 251, Internet access devices (Internet tablets) 250, personal computers 260 of various sizes and formats, televisions and other viewing devices 261, video decoders and players 262, as well as video cameras 263 and other encoders. These devices 250, 251, 260, 261, 262 and 263 can also be made of multiple parts. The various devices may be connected to the networks 210 and 220 via communication connections such as a fixed connection 270, 271, 272 and 280 to the internet, a wireless connection 273 to the internet 210, a fixed connection 275 to the mobile network 220, and a wireless connection 278, 279 and 282 to the mobile network 220. The connections 271-282 are implemented by means of communication interfaces at the respective ends of the communication connection.

FIG. 1b shows devices for a virtual presence system according to an example embodiment. As shown in FIG. 1b, the server 240 contains memory 245, one or more processors 246, 247, and computer program code 248 residing in the memory 245 for implementing, for example, a virtual presence system. The different servers 241, 242, 290 may contain at least these elements for employing functionality relevant to each server.

Similarly, the end-user device 251 contains memory 252, at least one processor 253 and 256, and computer program code 254 residing in the memory 252 for implementing, for example, gesture recognition. The end-user device may also have one or more cameras 255 and 259 for capturing image data, for example stereo video. The end-user device may also contain one, two or more microphones 257 and 258 for capturing sound. The end-user device may also contain sensors for generating the depth information using any suitable technology. The different end-user devices 250, 260 may contain at least these same elements for employing functionality relevant to each device. In another embodiment of this invention, the depth maps (i.e. depth information regarding the distance from the scene to a plane defined by the camera) obtained by interpreting video recordings from the stereo (or multiple) cameras may be utilized in the virtual presence system. The end-user device may also have a time-of-flight camera, whereby the depth map may be obtained from a time-of-flight camera or from a combination of stereo (or multiple) view depth map and a time-of-flight camera. The end-user device may generate depth map for the captured content using any available and suitable mechanism.

At least one of the cameras 255, 259 may operate as a front camera and at least one of the cameras may operate as a back camera for taking and processing images. The term “front camera” refers herein to the camera facing the user and typically locating on the display side of the device. The front camera is typically used for video telephony. The term “back camera” refers herein to the camera facing an opposite direction to the front camera. The back camera is the main camera of the device.

The end-user device may also comprise a GPS system for providing the location data of the apparatus, a compass for providing the orientation of the apparatus, an accelerometer and/or a gyroscope for providing information about the movements of the apparatus. The context data provided by these sensors can be used in determining e.g. the location and orientation of the device.

The end user devices may also comprise a screen for viewing single-view, stereoscopic (2-view), or multiview (more-than-2-view) images. The end-user devices may also be connected to video glasses 290 e.g. by means of a communication block 293 able to receive and/or transmit information. The glasses may contain separate eye elements 291 and 292 for the left and right eye. These eye elements may either show a picture for viewing, or they may comprise a shutter functionality e.g. to block every other picture in an alternating manner to provide the two views of three-dimensional picture to the eyes, or they may comprise mutually orthogonal polarization filters, which, when connected to similar polarization realized on the screen, provide the separate views to the eyes. Other arrangements for video glasses may also be used to provide stereoscopic viewing capability. Stereoscopic or multiview screens may also be autostereoscopic, i.e. the screen may comprise or may be overlaid by an optics arrangement, which results into a different view being perceived by each eye. Single-view, stereoscopic, and multiview screens may also be operationally connected to viewer tracking in such a manner that the displayed views depend on viewer's position, distance, and/or direction of gaze relative to the screen.

It needs to be understood that different embodiments allow different parts to be carried out in different elements. For example, parallelized processes of the virtual presence system may be carried out in one or more processing devices; i.e. entirely in one user device like 250, 251 or 260, or in one server device 240, 241, 242 or 290, or across multiple user devices 250, 251, 260 or across multiple network devices 240, 241, 242, 290, or across both user devices 250, 251, 260 and network devices 240, 241, 242, 290. The elements of the virtual presence system may be implemented as a software component residing on one device or distributed across several devices, as mentioned above, for example so that the devices form a so-called cloud.

As mentioned above, a user may wish to take images of him/herself when visiting new places, and to share the image in a social network service for other users to see. However, when trying to take an illustrative picture of oneself together with a distinct image of an object of interest, such as a building, being captured on the background of the image, the resulting image typically is of poor quality and, in most cases, it may not provide any illustrated information worth sharing in social network.

In order to alleviate these problems, a new method for creating images with virtual presence is presented herein. The method utilizes location information of the device capturing an image of an object of interest and retrieves a corresponding image of the object of interest from a place exploration service, such as Google® Street View or Nokia® City Scene. Then a virtual presence image is created by embedding an image of the user of the device thereto.

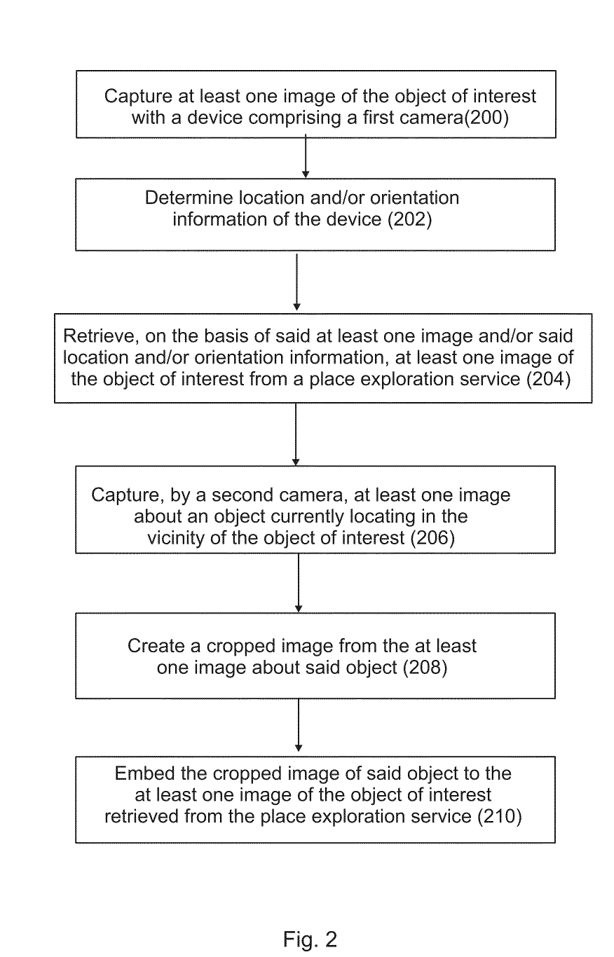

A method according to an embodiment is now described by referring to the flow chart of FIG. 2. In the method, a user of a device equipped with a first camera, captures (200) at least one (first) image about a first object of interest. The capturing may involve taking one or more still images about the object, or capturing a video about the object. The first object of interest may be, for example, an attraction or any public physical object, such as a statue or a building in a geographical location. At least one, but preferably both of the location and the orientation information of the device is determined (202). The device may obtain the location information, for example, using a satellite navigation system, such as GPS, and utilize the compass sensor for obtaining the orientation information.

Then, on the basis of at least one of said at least one first image and said location and orientation information, at least one second image of the first object of interest is retrieved (204) from a service comprising media associated with location information, referred hereinafter as a place exploration service. The place exploration service may be any two-dimensional (2D) or three-dimensional (3D) virtual world application, such as Google® Street View or Nokia® City Scene, providing image views from real geographical locations. The place exploration service may also be a service storing geotagged 2D images and/or videos, where geotagging means that the content has been associated with the corresponding geographical location.

According to an embodiment, the captured first image or video shot along with the GPS and compass orientation data may be sent to a server functionally connected to the place exploration service, and the server performs the location analysis. An initial location estimate can be obtained based on the location and compass orientation data of the device, and the final matching may be carried out by a visual comparison of the image data against visual data stored in the place exploration service near the initially estimated location. In an embodiment, the matching may be carried out using visual content matching only. In another embodiment, the matching may be carried out using location data only. In this embodiment, the orientation may not correspond to the actual orientation of the user, but this may be a valid scenario in, for example, very low network bandwidth implementations. In a further embodiment, the matching may be carried out using only location and orientation data.

Then at least one third image about a second object currently locating in the vicinity of the first object of interest is captured (206) by the first camera or by a second camera. The second camera may be a second camera, such as a front camera, of the device, and the second object may be the user of the device. Alternatively, the second camera may be a camera of a second device, and the second object may be either the user of the first device or the user of the second device. In any case, the second object is preferably locating within a predetermined range from the first object. It is, for example, possible to use the location information of the first/second camera capturing the third image about the second object and the location information of the first object to ensure that the first and the second objects are located within a predetermined range, e.g. distance, from each other. It is further possible to define the range such that the objects are within the predetermined range if the objects can be arranged into a single image of a camera.

From the at least one third image about said second object, a cropped image is created (208), which in one embodiment comprises at least a cropped portion of the user body, such as a cropped head of the person. The cropped image may further comprise at least a part of the person's body, if that is visible in the captured image. The cropped image may also be an avatar of the person, possibly created on the basis of said cropped image. If the person's body is not visible, it is possible to create at least part of the body as an artificially created avatar.

In general, the cropped image may be a part of the image captured by the second camera, and it may contain a portion of the user or not. For example, it may contain an object such as a flower, tree, car, or whatever object which the user wants to include in the place exploration service. In some embodiments, the user of the device capturing the second image may indicate the region which is to be cropped. Such indication may be done, e.g., by drawing the boundaries of the region to be cropped on the touch screen of a device.

Finally, the cropped image of said second object is embedded (210) to the second image of the first object of interest retrieved from the place exploration service. As a result, a user-generated fourth image is created, showing the second object, such as the user of the device or at least his/her avatar in the geographical location at the time when the image about the user was taken. The fourth image with the cropped image of the second object embedded to the at least one second image of the first object of interest retrieved from the place exploration service may then be stored in a network server, and access to the fourth image may be shared to at least one further person.

The user-generated fourth image may be stored, for example, in a database in connection with the place exploration service, and it may be shown to other users of the place exploration service visiting the corresponding virtual location. Naturally, the user-generated fourth image may be stored in the memory of the user device.

A skilled man appreciates that the order of the above steps may vary without affecting the desired technical effect. For example, the image or video about the person currently locating in the vicinity of the object of interest may be captured by the second camera before or simultaneously with capturing the at least one image about the object of interest. Thus, the image or video about the person may be sent to the server functionally connected to the place exploration service, whereby said image may further facilitate the server to perform the location analysis.

The actual implementation may take place in one or more client applications residing in one or more terminal devices and at least one server application residing in a server functionally connected to a place exploration service. The above steps may be shared among the client and server applications in a plurality of ways.

For example, embedding the cropped image of the person to the image of the object of interest may take place either in client application or in the server application. If it takes place in the client application, the client device must retrieve the image of the object of interest from the place exploration service, embed the person's image to the image of the object of interest, and then send the image generated in the client device back to the place exploration service. If the embedding of the cropped image of the person to the image of the object of interest takes in the server application, the user of the client application may only send the person's image to the place exploration service and request the image to be embedded to the image of the object of interest.

Moreover, an image (or a video) about the user of the first device may be taken by the person himself, for example using the front camera of the first device, or it can be taken by a user of a second device, whereafter the image/video is sent to the first device, for example via a close-proximity radio connection, such as a connection based on WLAN, Bluetooth, NFC (Near-Field Connection) or RFID (Radio Frequency Identification) technology. It is also possible that the second device sends the image/video directly to the place exploration service. Herein, sending may refer to uploading, streaming, or otherwise transmitting the data of the image/video from one device to another.

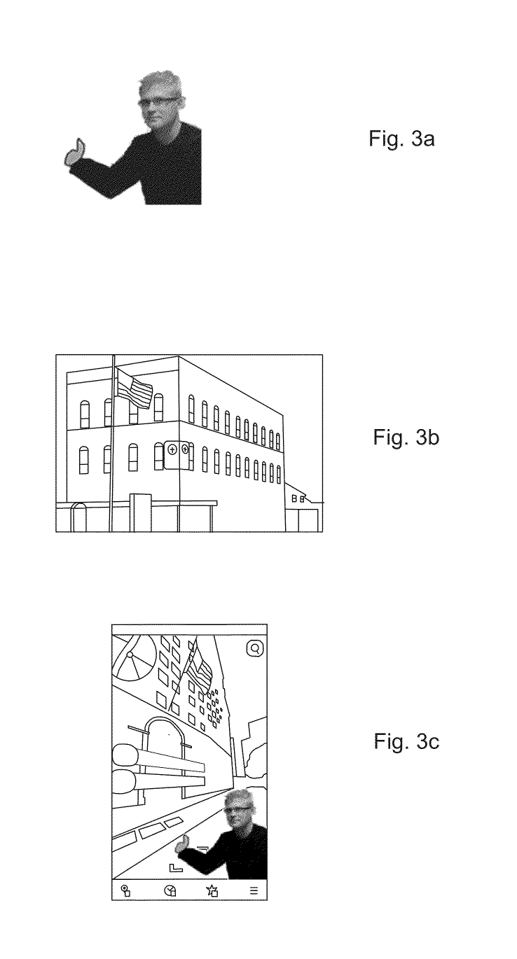

FIGS. 3a-3c show an illustrative example of the embodiment. FIG. 3a shows a cropped image about a person currently locating in the vicinity of the object of interest, i.e. the user of the first device. The image may be taken using the front camera of the first device, or it can be taken by a user of a second device, and transferred to the first device. FIG. 3a also shows how a part of the body, in this case an arm and a hand, can be created as an artificially created avatar.

FIG. 3b shows an image/video taken about the object of interest by the first device. On the basis of this image/video and the location and compass orientation data of the first device, a street view image corresponding to said data is retrieved from a place exploration service.

FIG. 3c shows an example of a street view image retrieved from the place exploration service, on which the image about the user of the first device is embedded. It should be noted that the place exploration service may not necessary contain an image of the object of interest, and therefore an image matching closest to the criteria (i.e. image data of the object of interest and the location and orientation information from the first device) may be offered for creating the user-generated image.

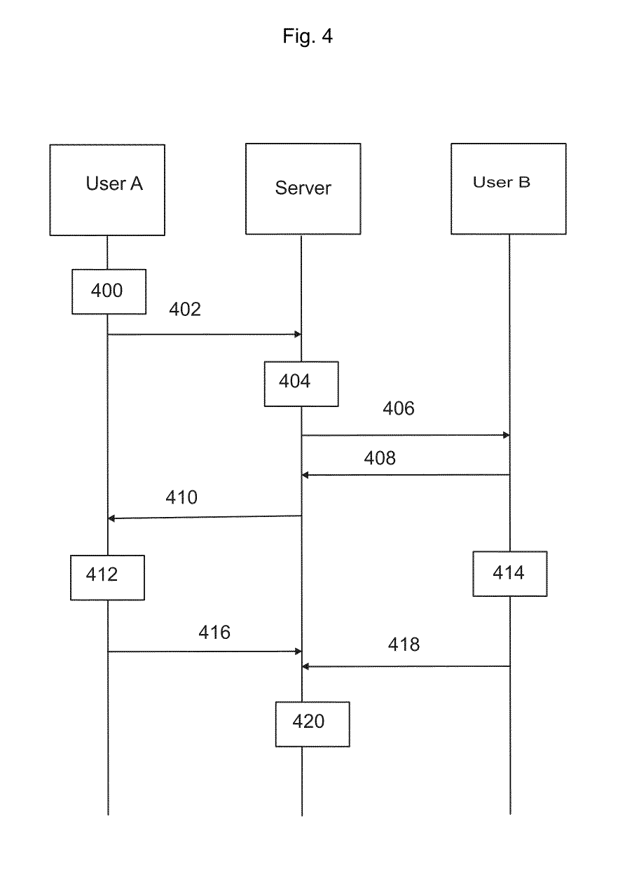

A method according to an alternative embodiment is now described by referring to the signaling chart of FIG. 4. In the method, instead of using images retrieved from a place exploration service, images or videos captured by another device are used as a basis for creating the user-generated image with a cropped image embedded thereto. The service described by the method may, for example, be based on the idea that the service keeps track of the places where the users of the service are currently visiting and where they have visited, and a user may request the user-generated image to be created only from places he/she has visited previously. The cropped image may contain a person who has visited a place but did not manage to capture a photo of him/herself at the location. The cropped image may also contain some other visual object, such as a doll or a flower vase, which the user would like to portray him/herself instead of a picture of him/herself.

Thus, the user A of a first client terminal selects (400) a place he/she has visited before and from where he/she would like to obtain a user-generated first image with a cropped image of an object embedded thereto. The object of the cropped image may be, for example, the user A himself/herself or some other object than the user A. According to an embodiment, the service may provide a template for the user A to select from the places stored in the service as places where the user A has visited previously. According to an embodiment, the user may include further definitions about the first object of interest to the selected place; for example, Place=“Paris”+“place me next to the Eiffel tower”. Alternatively, the user may generate such a request as free writing without any specific template.

The request is sent (402) to the server running the service, whereupon the server checks (404) if any user of the service is currently visiting the requested place. It is detected that the user B of a second client terminal is currently visiting the requested place, and the request is forwarded (406) to the user B. Again, it is possible to use the location information of the second client device and the location information of the first object to ensure that the first object and the second client device are located within a predetermined range from each other.

The user B then confirms by an acknowledgement (408) that he/she is available for capturing a second image or video about the requested first object. The acknowledgement is forwarded (410) from the server to the user A. The user A starts to capture (412) a video or at least one third image about the second object, such as about him/herself, for example using the front camera of the first client device. The user B starts to capture (414) a video or at least one second image about the requested first object of interest.

The videos or the at least second and third images captured by the users A and B are collected to a common editing node, which in FIG. 4 is the server. Thus, the video or the at least one third image captured by the user A is transmitted (416) to the server, and similarly, the video or the at least one second image captured by the user B is transmitted (418) to the server. The server then performs the editing (420) by creating a cropped image from the video or the at least one third image about the second object, and embedding the cropped image of the second object to the video or the at least one second image of the first object of interest captured by the user B.

Instead of using the server as the common editing node, it is possible to carry out the editing either on the first client terminal (user's A terminal) or on the second client terminal (user's B terminal). In either case, it is only required to transmit the video or the at least one image lacking from the client terminal.

According to an embodiment, regardless of which common editing node is used, the edited video or image comprising the cropped image of the second object embedded to the video or the at least one image of the object of interest captured by the user B is provided to the first client terminal for showing it to the user A. According to an embodiment, the user A may be provided with an option to give instructions to the user B for adjusting the capture, for example to use different view angle or orientation, improving the lightning conditions, zooming closer/further, etc. The user A may then indicate when he/she is satisfied with the capture, whereupon the user B takes the final capture for editing in common editing node.

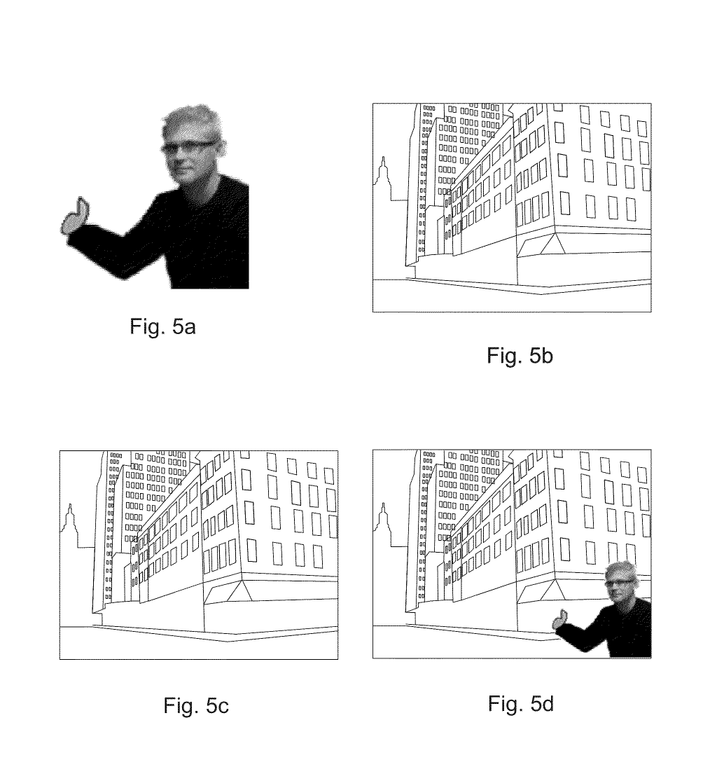

FIGS. 5a-5d show an illustrative example of the embodiment. FIG. 5a shows a similar cropped image about the user A of the first device as in FIG. 3a. The image may be taken using the front or the back camera of the first device, or it can be taken by a user of another device, and transferred to the first device.

FIG. 5b shows an image/video about the object of interest, defined by the user A and taken by the user B of the second device. The image may be taken, for example, using the back camera of the second device.

The user A may then give instructions to the user B for adjusting the capture, if considered necessary. When the user A indicates to the user B that the image is satisfyingly adjusted, the user B takes the final capture about the object of interest. This is shown in FIG. 5c.

FIG. 5d shows an example of the final capture image taken about the object of interest by the user B of the second device, on which the image about the user A of the first device is embedded.

A skilled man appreciates that any of the embodiments described above may be implemented as a combination with one or more of the other embodiments, unless there is explicitly or implicitly stated that certain embodiments are only alternatives to each other.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, or CD.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

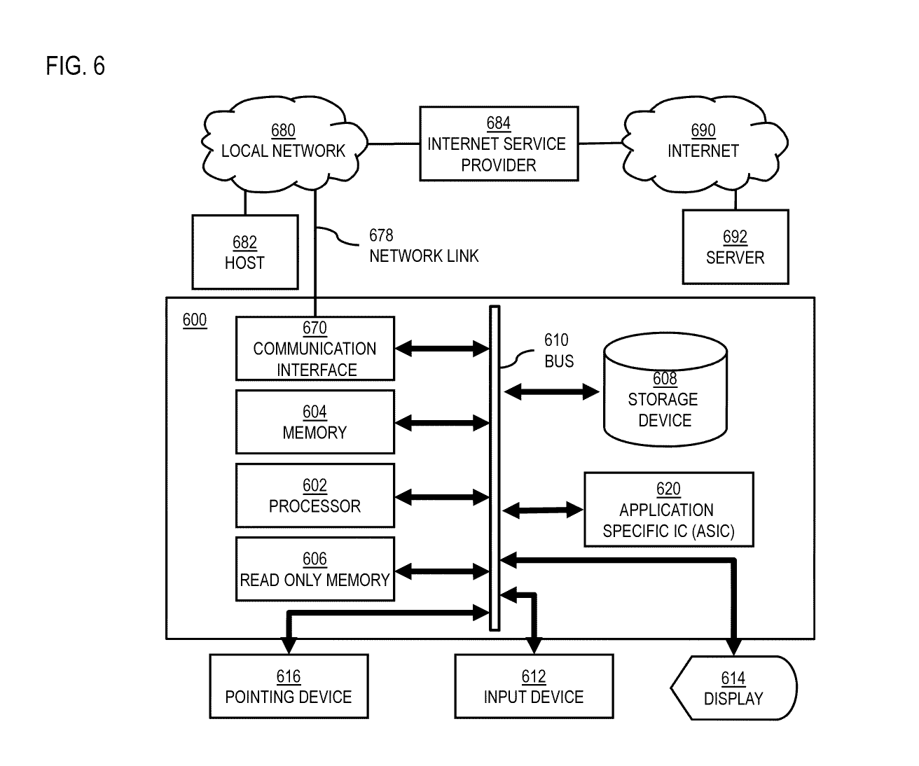

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to provide a virtual presence system as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of providing a virtual presence system.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to providing a virtual presence system. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or any other dynamic storage device, stores information including processor instructions for providing a virtual presence system. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or any other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for providing a virtual presence system, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of ASICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to a communication network for providing a virtual presence system.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media.

Non-transitory media, such as non-volatile media, include, for example, optical or magnetic disks, such as storage device 608. Volatile media include, for example, dynamic memory 604. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or any other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

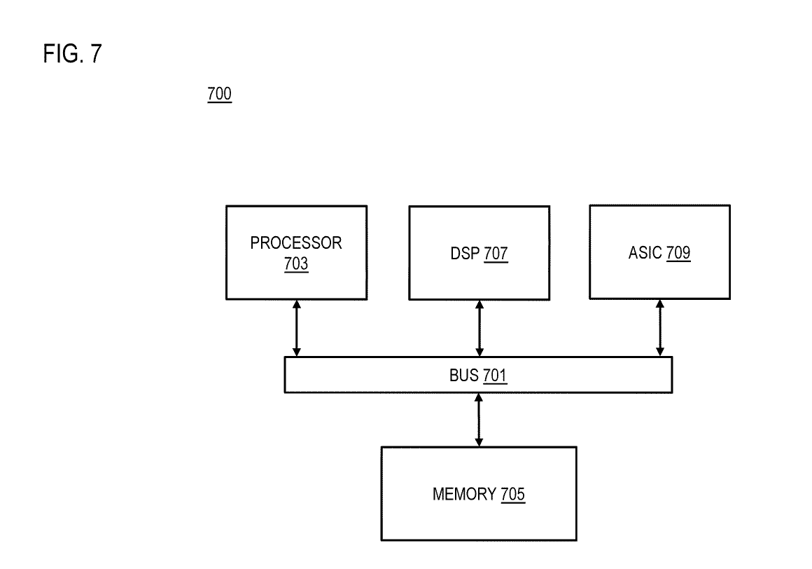

FIG. 7 illustrates a chip set or chip 700 upon which an embodiment of the invention may be implemented. Chip set 700 is programmed to provide a virtual presence system as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of providing a virtual presence system.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to provide a virtual presence system. The memory 705 also stores the data associated with or generated by the execution of the inventive steps.

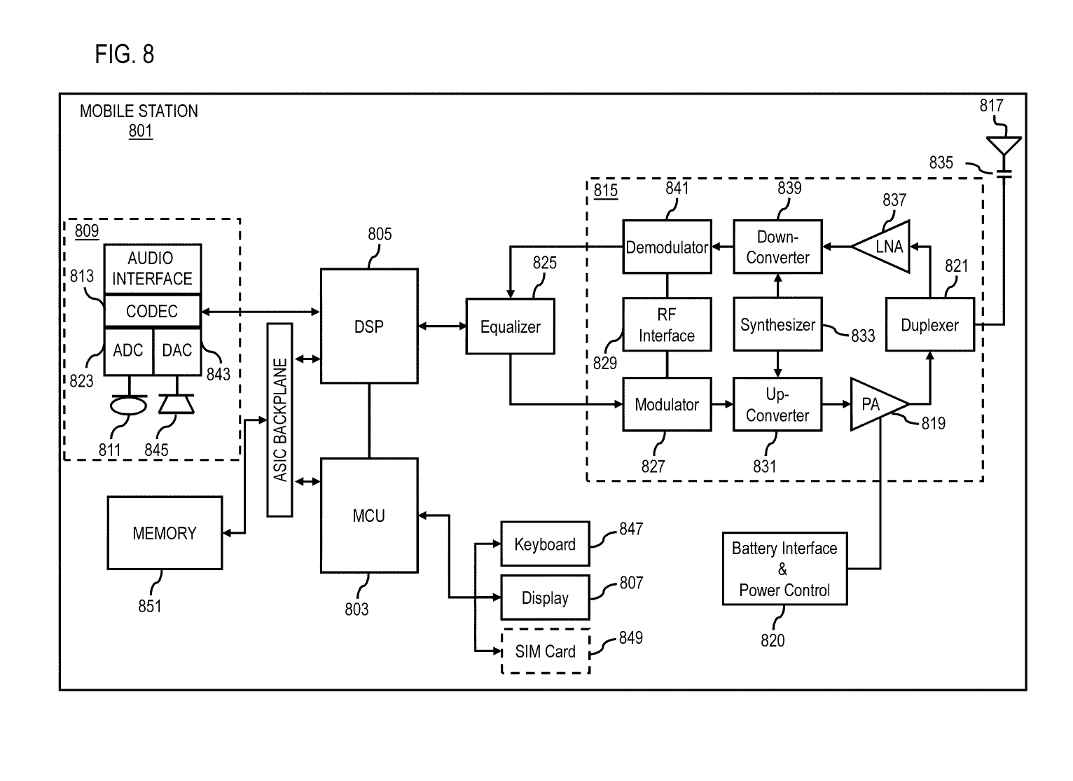

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of providing a virtual presence system. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of providing a virtual presence system. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803 which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to providing a virtual presence system. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

1. A method comprising:
capturing, by a device equipped with a first camera, at least a first image about a first object of interest;
determining at least one of location and orientation information of the device;
retrieving, on the basis of at least one of said at least one first image and said location and orientation information, at least one second image of the first object of interest from a service comprising media associated with location information;
capturing at least a third image about a second object currently locating within a predetermined range from the first object of interest;
creating a cropped image from the at least one third image about said second object, the cropped image comprising at least a cropped portion of said second object; and
embedding the cropped image of said second object to the at least one second image of the first object of interest retrieved from said service in order to form a fourth image.

2. A method according to claim 1, wherein
the third image about the second object is captured by a second camera.

3. A method according to claim 2, wherein
the first camera is a back camera of the device and the second camera is a front camera of said device, and
said second object is a user of the device.

4. A method according to claim 2, wherein
the first camera is a camera of a first device and the second camera is a camera of a second device, and said second object is a user of the first device, the method further comprising
sending the at least one third image about the second object to the first device.

5. A method according to claim 1, further comprising
storing the fourth image in a network server; and
sharing access to the fourth image to at least one further person.

6. A method according to claim 1, wherein
the service is a three-dimensional (3D) virtual application providing image views from real geographical locations.

7. A method according to claim 1, further comprising
sending the at least one first image about the first object of interest and the location and orientation information together to a server functionally connected to said service for determining the location of the device.

8. A method according to claim 1, wherein
said cropped image is an avatar of a person

9. An apparatus comprising at least one processor, memory including computer program code, the memory and the computer program code configured to, with the at least one processor, cause the apparatus to at least:
capture, with a first camera, at least one first image about a first object of interest;
determine at least one of location and orientation information of the device;
retrieve, on the basis of at least one of said at least one first image and said location and orientation information, at least one second image of the first object of interest from a service comprising media associated with location information;
obtain at least one third image about a second object currently locating within a predetermined range from the first object of interest;
create a cropped image from the at least one third image about said second object, the cropped image comprising at least a cropped portion of said second object; and
embed the cropped image of said second object to the at least one second image of the first object of interest retrieved from said service in order to form a fourth image.

10. An apparatus according to claim 9, wherein
the third image about the second object is arranged to be captured by a second camera.

11. An apparatus according to claim 10, wherein
the first camera is a back camera of the apparatus and the second camera is a front camera of said apparatus, and
said second object is a user of the apparatus.

12. An apparatus according to claim 10, wherein
the first camera is a camera of the apparatus and the second camera is a camera of a second apparatus, and said second object is a user of the first apparatus, the apparatus being configured to
receive the at least one third image about the second object from the second apparatus.

13. An apparatus according to claim 9, the apparatus being further configured to
store the fourth image in a network server; and
share access to the image to at least one further person.

14. An apparatus according to claim 9, wherein
the service is a three-dimensional (3D) virtual application providing image views from real geographical locations.

15. An apparatus according to claim 9, the apparatus being further configured to
send the at least one first image about the first object of interest and the location and orientation information together to a server functionally connected to said service for determining the location of the device.

16. An apparatus according to claim 9, wherein
said cropped image is an avatar of a person.

17. A computer program embodied on a non-transitory computer readable medium, the computer program comprising instructions causing, when executed on at least one processor, at least one apparatus to:
capture, with a first camera, at least one first image about a first object of interest;
determine at least one of location and orientation information of the device;
retrieve, on the basis of at least one of said at least one first image and said location and orientation information, at least one second image of the first object of interest from a service comprising media associated with location information;
obtain at least one third image about a second object currently locating within a predetermined range from the first object of interest;
create a cropped image from the at least one third image about said second object, the cropped image comprising at least a cropped portion of said second object; and
embed the cropped image of said second object to the at least one second image of the first object of interest retrieved from said service in order to form a fourth image.

18. A method comprising:
receiving a request from a user of a first client terminal to create at least one first image comprising a first object of interest defined by the request and a cropped image of a second object embedded thereto;
sending a request to a second client terminal currently locating within a predetermined range from the first object of interest for capturing at least one second image about the first object;
receiving, in response to an acknowledgement from the second client device, at least one third image of the second object from the first client terminal;
receiving, from the second client device, the at least one second image about the first object of interest; and
editing the received images by creating a cropped image from the at least one third image about the second object, and embedding the cropped image of the second object to the at least one second image of the first object of interest captured by the second client terminal in order to create the at least one first image.

19. A method according to claim 18, wherein the second object is a user of the first client terminal.

20. A method according to claim 18, further comprising
keeping track of places where the user of the first terminal has previously visited; and
allowing said requests to be made only in regard to such first object of interest residing in places where the user of the first terminal has previously visited.

21. A method according to claim 18, further comprising
providing the user of the first client terminal with an option for giving instructions to a user of the second client device for adjusting the capturing of the at least one second image of the first object of interest.

22. A method according to claim 18, wherein
the editing is carried out in a common editing node, the node being a network server, the first client device or the second client device.

23. An apparatus comprising at least one processor, memory including computer program code, the memory and the computer program code configured to, with the at least one processor, cause the apparatus to at least:
receive a request from a user of a first client terminal to create at least one first image comprising a first object of interest defined by the request and a cropped image of a second object embedded thereto;
send a request to a second client terminal currently locating within a predetermined range from the first object of interest for capturing at least one second image;
receive, in response to an acknowledgement from the second client device, at least one third image of the second object from the first client terminal;
receive, from the second client device, the at least one second image about the first object of interest; and
edit the received images by creating a cropped image from the at least one third image about the second object, and embedding the cropped image of second object to the at least one second image of the first object of interest captured by the second client terminal in order to create the at least one first image.

24. A computer program embodied on a non-transitory computer readable medium, the computer program comprising instructions causing, when executed on at least one processor, at least one apparatus to:
receive a request from a user of a first client terminal to create at least one first image comprising a first object of interest defined by the request and a cropped image of a second object embedded thereto;
send a request to a second client terminal currently locating within a predetermined range from the first object of interest for capturing at least one second image;
receive, in response to an acknowledgement from the second client device, at least one third image of the second object from the first client terminal;
receive, from the second client device, the at least one second image about the first object of interest; and
edit the received images by creating a cropped image from the at least one third image about the second object, and embedding the cropped image of second object to the at least one second image of the first object of interest captured by the second client terminal in order to create the at least one first image.
